(19) United States
(12) Patent Application Publication
(10) Pub. No.: US 2008/0138607 A1
(43) Pub. Date: Jun. 12, 2008

(54) METHOD OF FORMING AN ARTICLE INCLUDING A CURED FILM FORMED FROM A COIL COATING COMPOSITION

(75) Inventors: Daniel Calimente, Sterling Heights, MI (US); Edward J. Daraskevich, Oswego, IL (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/567,760

(22) Filed: Dec. 7, 2006

(51) Int. Cl. B05D 3/12; C08G 12/06; B32B 5/16

(52) U.S. Cl. 428/327; 427/276; 528/269; 528/363

(57) ABSTRACT

A method of forming an article including a substrate and a cured film formed from a coil coating composition on the substrate is provided. The coil coating composition comprises a precursor to the coil coating composition and a matting agent comprising an amide-based polymer. The coil coating composition is applied to the substrate and cured to form a cured film having a first region having a first film thickness and a first gloss. The substrate is deformed to establish a second region of the cured film having a second film thickness that is less than the first film thickness and a second gloss. A coil coating system including the substrate and the cured film disposed on the substrate is also provided. The matting agent stabilizes gloss of the cured film, minimizing a difference between the first gloss and the second gloss of the cured film on a deformed substrate.

### BACKGROUND OF THE INVENTION

1. Field of the Invention

The subject invention generally relates to a coil coating composition and a method of forming an article including a cured film formed from the coil coating composition on a substrate. More specifically, the subject invention relates to a cured film formed from the coil coating composition including a matting agent.

2. Description of the Prior Art

Coil coating compositions are a class of coating compositions that are typically applied to a substrate before the substrate is deformed into an article such as a roofing panel, an appliance, a component of tractor-trailer equipment, a door, a gutter, and a siding panel. Coil coating compositions have several advantages over conventional coating compositions. Coil coating compositions minimize coating loss during application and provide excellent cured film flexibility, uniformity, and durability. Consequently, coil coating compositions are typically used to provide substrates with certain functional and aesthetic qualities, such as color, gloss, and weather resistance.

Coil coating compositions may be applied to substrates to ensure a consistent gloss, which is a measure of specular reflection. Specular reflection results when light reflects off a smooth substrate so that an angle of incidence is equal to an angle of reflection. Gloss is measured by a glossmeter and expressed in Gloss Units, which range from 0 to 1,000. A higher Gloss Unit value indicates a higher gloss. A cured film with a relatively higher gloss will reflect more light as compared to a cured film with a relatively lower gloss.

Coil coating compositions include a resin, a cross-linking agent reactive with the resin, and one or more additives. The resin may be selected from the group of acrylics, polyvinylidine difluorides, polyesters, siliconized polyesters, polyvinyl chloride plastisols, and combinations thereof. Typical additives for improving the physical properties of the coil coating composition may include adhesion promoters, surfactants, thickeners, and matting agents.

As set forth above, the substrate is deformed into the article. Deforming may include bending, folding, stamping, twisting, and shaping the substrate. Substrates coated with cured films formed from coil coating compositions are deformed by subjecting the substrates to compression and tension forces. Such compression and tension forces also deform the cured films and create regions of decreased film thickness and increased gloss, thereby compromising the aesthetics of the articles.

Matting agents are added to coil coating compositions to decrease gloss. However, after substrates coated with cured films formed from coil coating compositions are deformed, regions of increased gloss may be visible on the substrates when a conventional matting agent is used. As a result, the articles do not meet quality specifications for appearance, i.e. the articles have some regions with higher gloss than other regions. It is typically difficult to maintain a consistent gloss in such cured films on substrates that are deformed. Therefore, it would be advantageous to maintain a consistent gloss of cured films formed from coil coating compositions on substrates that are deformed.

Various matting agents for stabilizing gloss of cured films formed from coating compositions are known in the prior art. An example of one such matting agent is disclosed in United States patent application No. 2005/0288450 to Fletcher. Specifically, Fletcher discloses a matting agent that comprises an amide-containing condensation product that is suitable for preparing epoxy, epoxy-polyester, polyester, polyester acrylic, polyester-primid, polyurethane, or acrylic coating compositions. Specifically, the matting agent optionally comprises at least one β-hydroxyalkylamide functional group to decrease the gloss of cured films formed from coating compositions.

Fletcher does not disclose deforming substrates coated with cured films formed from coil coating compositions to result in regions of different film thickness and gloss, nor does Fletcher disclose minimizing a difference between the gloss of the regions. Rather, Fletcher provides varying the film thickness of cured films formed from coating compositions only by applying cured films with varying film thicknesses. Fletcher does not provide varying the film thicknesses as a result of deforming the substrate. As such, Fletcher does not recognize the problems that are attendant with coil coating compositions, in particular.

Other types of matting agents, such as inorganic silica gels or organic polyethylene and polytetrafluoroethylene also do not provide consistent gloss on substrates coated with cured films formed from coil coating compositions that are deformed. Substrates coated with cured films formed from coil coating compositions comprising inorganic silica gels or organic polyethylene and polytetrafluoroethylene exhibit regions of different film thickness and inconsistent gloss when deformed. The inorganic silica gels and organic polyethylene and polytetrafluoroethylene do not provide consistent gloss on deformed substrates coated with coil coating compositions used in low-gloss applications.

Due to the deficiencies of the prior art, including Fletcher, there remains an opportunity for a method of forming an article including a cured film having consistent gloss formed from a coil coating composition on a substrate that is deformed. More specifically, there remains an opportunity to minimize a difference in gloss between regions of varying film thickness on a substrate that is deformed.

### SUMMARY OF THE INVENTION AND ADVANTAGES

The subject invention provides a method of forming an article including a substrate and a cured film formed from a coil coating composition on the substrate. The coil coating composition comprises a precursor to the coil coating composition and a matting agent comprising an amide-based polymer. The coil coating composition is applied to the substrate and cured to form a cured film that has a first region having a first film thickness and a first gloss. The substrate is deformed to establish a second region of the cured film having a second film thickness that is less than the first film thickness and a second gloss.

The subject invention also provides a coil coating system. The coil coating system includes the substrate and the cured film disposed on the substrate.

Due to the presence of the matting agent comprising the amide-based polymer, a difference in gloss between regions of varying film thickness, i.e., the first region and the second region, is minimized beyond what was previously capable through use of other matting agents. The matting agent stabilizes gloss of the cured film, and thereby minimizes the difference between the first gloss and the second gloss of the cured film on the deformed substrate.

### DETAILED DESCRIPTION OF THE INVENTION

The subject invention includes a coil coating system and a method of forming an article including a substrate and a cured film formed from the coil coating composition on the substrate. Coil coating compositions, as used herein, are a class of coating compositions that are applied to substrates before the substrates are deformed into articles. Typical applications for coil coating compositions include the appliance, tractor-trailer equipment, consumer electronics, heating, ventilation and air conditioning, and commercial and residential building industries. The substrates are deformed, for example, by bending, folding, stamping, twisting, and shaping the substrates into articles such as roofing panels, appliances, tractor-trailer equipment, doors, gutters, and siding after the coil coating composition is applied. It is to be understood that coil coating compositions can have applications beyond coil coating applications, such as automotive coating applications, so long as the coil coating compositions are applied to the substrate and cured before the substrate is deformed.

The method of forming the article including the substrate and the cured film formed from the coil coating composition on the substrate comprises the step of providing the coil coating composition comprising a precursor to the coil coating composition and a matting agent. The precursor to the coil coating composition may include a resin and a cross-linking agent that is reactive with the resin. The resin may be selected from the group of polyester resins, polyvinylidine diflouride resins, siliconized polyester resins, acrylic resins, polyvinyl chloride plastisol resins, and combinations thereof.

A polyester resin that is suitable for purposes of the present invention is typically produced by a condensation reaction between polyols, predominantly diols and triols, and polycarboxylic acids or corresponding anhydrides. Polyols that may be used to form the polyester resin typically contain from about 2 to 20 carbon atoms. Aliphatic polyols, particularly aliphatic diols or triols containing from 2 to 10 carbon atoms, are preferred. Specific examples of suitable polyols include, but are not limited to, ethylene glycol, 1,2-propanediol, 1,3-propanediol, 1,3-propylene glycol, 1,4-butanediol, 1,4-butylene glycol, 1,5-pentanediol, glycerol, 1,2,3-butanetriol, 1,6-hexanediol, neopentyl glycol, diethylene glycol, 2-methyl-1,3-propanediol, dipropylene glycol, 2-methyl-1,3-propanediol, trimethylolethane, trimethylolpropane, triethyleneglycol, 2,2,4-trimethylpentane-1,3-diol, 2,2-dimethyl-3-hydroxypropyl 2,2-dimethyl-3-hydroxypropionate, 1,4-cyclohexanedimethanol, 1,4-cyclohexanediol, pentaerythritol, and dipentaerythritol. Combinations of two or more polyols may also be used. Triols, such as trimethylolpropane, are typically used at low levels to provide branching to the polyester resin if desired.

Polycarboxylic acids typically used in the condensation reaction to make the polyester resin include, but are not limited to, adipic, methyladipic, malonic, sebacic, suberic, glutaric, fumaric, itaconic, malic, diglycolic, the 1,3- and 1,4-cyclohexanedicarboxylic acids, pimelic, azelaic, 1,12-dodecanedioic, maleic acid, maleic anhydride, succinic acid, succinic anhydride, methylsuccinic and tetrapropenyl succinic acids and their anhydrides, and tetrahydrophthalic anhydride. Combinations of two or more polycarboxylic acids can also be used. Examples of aromatic polycarboxylic acids which may be used in place of or in combination with the aliphatic or cycloaliphatic acids include phthalic acids and phthalic anhydride, benzophenone dicarboxylic acid, diphenic acid, 4,4-dicarboxydiphenyl ether, and trimellitic acid. A suitable polyester resin for the purposes of this invention is commercially available from BASF Corporation of Florham Park, N.J.

A polyvinylidine diflouride resin that is suitable for purposes of the present invention is typically synthesized from a gaseous vinylidine diflouride monomer via a free radical polymerization process. A suitable polyvinylidine diflouride resin for the purposes of this invention includes Kynar 500®, commercially available from Arkema Inc. of Philadelphia, Pa.

An acrylic resin that is suitable for purposes of the present invention may be derived from acrylic acid. To form the acrylic resin, acrylic acid is typically reacted with an alcohol to form a carboxylic ester. The carboxylic ester may combine with itself or monomers to form the acrylic resin, which may be a homopolymer. Acrylic resins may be used in combination with the resins listed above, for example polyester resins or polyvinylidine resins, in solution to aid in flow of the coil coating composition. In an embodiment when the acrylic resin is used in combination with the polyester resin, for example, the acrylic resin may be present in an amount of from 2 to 20, preferably from 5 to 15, and most preferably from 5 to 10 parts by weight based on 100 parts by weight of the coil coating composition. A suitable acrylic resin for the purposes of this invention is commercially available from BASF Corporation of Florham Park, N.J.

A siliconized polyester resin that is suitable for purposes of the present invention typically includes a silicon-modified polyester resin. A suitable siliconized polyester resin for the purposes of this invention is commercially available from BASF Corporation of Florham Park, N.J.

A polyvinyl chloride plastisol resin that is suitable for purposes of the present invention is typically a dispersion in plasticizers of fine particle-size polyvinyl chloride. The polyvinyl chloride plastisol is typically prepared from a vinyl chloride paste resin, which typically includes vinyl chloride resin particles up to 10 microns in size. The vinyl chloride particles are typically solid, smooth-surfaced spheres. The vinyl chloride paste resin may be combined with stabilizers, plasticizers, lubricants, and fillers to produce the polyvinyl chloride plastisol resin. Suitable stabilizers may include tribasic lead, dibasic lead phosphate, dibasic lead phthalate, and metal soaps, such as lead stearate and cadmium stearate. Useful plasticizers may include dioctyl phthalate, dioctyl adipate, dioctyl sebacate, and paraffin chloride. Suitable lubricants may include stearic acid, palmitic acid, saturated fatty acids and esters thereof, ethers, and waxes. Useful fillers typically include barium sulfate, precipitated calcium carbonate, and granulated calcium carbonate. A suitable polyvinyl chloride plastisol resin for the purposes of this invention includes Geon® 179, commercially available from PolyOne of Avon Lake, Ohio.

The resin may be present in an amount of from 30 to 70, preferably from 40 to 65, and most preferably from 50 to 55 parts by weight based on 100 parts by weight of the coil coating composition.

As set forth above, the precursor to the coil coating composition may further include the cross-linking agent that is reactive with the resin. Such cross-linking agents are known in the art, and the specific cross-linking agent may depend upon the type of resin used. For example, in the embodiment of the coil coating composition formed from the polyester resin, the cross-linking agent is typically reactive with active hydrogen atoms in the polyester resin to establish the cured film.

The cross-linking agent reactive with the polyester resin may comprise a melamine formaldehyde resin. One example of a suitable melamine formaldehyde resin is a fully methylated melamine. As such, the melamine formaldehyde resin may include alkoxymethyl groups of the general formula:

—CH₂OR₁

where R₁ is an alkyl chain having from 1 to 20 carbon atoms. A specific example of a suitable melamine formaldehyde resin for the purposes of this invention is hexamethoxymethyl melamine under the tradename Resimene®, commercially available from Solutia of St. Louis, Mo.

Other cross-linking agents may also be suitable. For example, the cross-linking agent may be other monomeric and polymeric melamine formaldehyde resins, including both partially and fully alkylated melamines, such as other methylated melamines, butylated melamines, and methylated/butylated melamines. The cross-linking agent can also be other aminoplasts including, but not limited to, urea resins such as methylol ureas and alkoxy ureas, e.g. butylated urea formaldehyde resin. It is to be appreciated that other cross-linking agents reactive with the resins listed above and known in the art may be suitable for the purposes of this invention. The cross-linking agent may be present in an amount from 0.5 to 3, preferably from 1 to 2 parts by weight based on 100 parts by weight of the coil coating composition.

The precursor to the coil coating composition also typically comprises a solvent. The solvent may be any organic solvent known in the art and/or water. Useful solvents may include, but are not limited to, aromatic hydrocarbons, ketones, esters, glycol ethers, and esters of glycol ethers. Specific examples of solvents may include, but are not limited to, methyl ethyl ketone, methyl isobutyl ketone, m-amyl acetate, ethylene glycol butyl ether and ethylene glycol monobutyl ether acetate, propylene glycol monomethyl ether and propylene glycol monomethyl ether acetate, xylene, N-methylpyrolidone, blends of aromatic hydrocarbons, and combinations thereof. The solvent may be present in an amount from 25 to 60, preferably from 30 to 50, and most preferably from 35 to 45 parts by weight based on 100 parts by weight of the coil coating composition. A suitable solvent for the purposes of this invention include Curox®M-100, commercially available from Degussa AG of Marl, Germany.

The precursor to the coil coating composition may also include an additive. Typical additives may be selected from the group of waxes, surfactants, fillers, plasticizers, emulsifiers, texturizers, catalysts, thickeners, adhesion promoters, stabilizers, defoaming agents, wetting additives, colored pigments, and combinations thereof. The additive may be present in an amount of from 1 to 20, preferably from 5 to 15, and most preferably from 7 to 12 parts by weight based on 100 parts by weight of the coil coating composition.

As set forth above, the coil coating composition comprises the matting agent comprising the amide-based polymer in addition to the precursor to the coil coating composition. The terminology “amide-based polymer” is defined to mean that the polymer comprises at least one amide functional group. Although it is believed that any amide-based polymer will provide an improvement over matting agents used in prior art coil coating compositions, urea-formaldehyde based polymers have proven particularly useful for purposes of this invention.

The urea formaldehyde polymer typically includes repeating units of the general formula:

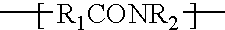

where R₁ is an amine group and R₂ is an alkyl group.

The matting agent typically has a particle size of from about 5 to 60 μm as measured in accordance with ISO 1524 to provide excellent mixing with the precursor to the coil coating composition and to produce the smooth cured film. The precursor to the coil coating composition and the matting agent are typically mixed according to methods as known in the art, for example under agitation, to form the coil coating composition. The matting agent is typically present in the coil coating composition in an amount of from 0.1 to 10, more preferably of from 1 to 7, and most preferably of from 2 to 5 parts by weight based on 100 parts by weight of the coil coating composition. A suitable urea formaldehyde polymer for the purposes of this invention is Ceraflour® 920, commercially available from BYK-Chemie GmbH of Germany.

The method of forming the article further includes the step of applying the coil coating composition to the substrate. The substrate is typically metal, for example, steel or aluminum. However, it is to be appreciated that the substrate may also be other materials, such as plastic or fiber.

Without intending to be limiting, the step of applying the coil coating composition to the substrate is typically performed using at least one roller. In one embodiment, the step of applying the coil coating composition occurs with a two roller process. For example, a first roller that rotates in a first direction may be provided. The first roller may transfer the coil coating composition from an open holding receptacle to a second roller that rotates in an opposite direction to the first direction of the first roller. The second roller may transfer the coil coating composition to the substrate. It is to be appreciated that other methods of applying the coil coating composition to the substrate may also be employed. For example, the coil coating composition may be sprayed or applied by hand.

The method of forming the article further includes the step of curing the coil coating composition on the substrate to form the cured film. The step of curing the coil coating composition to form the cured film is typically conducted at a temperature of from 400° F. to 900° F. for a period of from 15 to 100 seconds. The step of curing the coil coating composition typically occurs in an oven, although the coil coating composition may be cured using an open heat source. Once the coil coating composition is cured to form the cured film, the cured film is typically cooled to about an ambient temperature. The cured film on the substrate may be sprayed with a coolant, such as water, to effect the cooling.

Once the cured coil coating composition is cured as set forth above, the cured film has a first region having a first film thickness and a first gloss. The first region is defined as the region of the substrate that remains unmodified. That is, the first region is any region having consistent film thicknesses before and after the substrate is deformed, as described below. In fact, the entire coated substrate may represent the first region. The first film thickness may be measured in accordance with ASTM D1005 and the first gloss may be measured in accordance with ASTM D523. The first gloss is typically less than about 15, more preferably less than 10, and most preferably less than 5 at all wavelengths in a visible spectrum as measured by a glossmeter at 60°.

The method of forming the article includes the step of deforming the substrate. The substrate is typically deformed by bending the substrate, folding the substrate, stamping the substrate, twisting the substrate, shaping the substrate, and combinations thereof.

The step of deforming the substrate establishes a second region of the cured film. The second region is defined as the region of the substrate that has been deformed. That is, the second region is any region having different film thicknesses after the substrate is deformed than prior to deformation.

The second region is typically established in deformed areas of the substrate, such as creases, bends, valleys, crevices, and folds. The second region has a second film thickness that is less than the first film thickness, and a second gloss as measured by a glossmeter at 60°. For example, as the substrate is deformed through bending the substrate, the cured film in the second region may be stretched such that the first film thickness decreases and the first gloss increases to establish the second film thickness and the second gloss. In one embodiment, for example, the substrate may be stamped to form a wave pattern on the substrate with peaks having the second film thickness and the second gloss, and valleys having the first film thickness and the first gloss. Typically, the second film thickness is less than or equal to 50% of the first film thickness. Due to the presence of the matting agent in accordance with the present invention, after deformation, a difference between the first gloss and the second gloss is typically less than or equal to about 15%, more preferably about 10%, and most preferably about 5% of the first gloss.

The subject invention also provides the coil coating system. The coil coating system includes the substrate and the cured film disposed on the substrate. The cured film has the first region having the first film thickness and the first gloss as measured by a glossmeter at 60°. The cured film has the second region having the second film thickness that is less than the first film thickness and the second gloss. The cured film is formed from the coil coating composition as set forth above comprising the precursor to the coil coating composition and the matting agent comprising the amide-based polymer.

### EXAMPLES

The following examples are meant to illustrate the invention and are not to be viewed in any way as limiting to the scope of the invention.

An article including a cured film formed form a coil coating composition is produced in accordance with the method of the present invention. More specifically, the article is produced by applying the coil coating composition to a substrate and curing the coil coating composition to form the cured film.

The coil coating composition is produced by a batch blending process where a precursor to the coil coating composition and a matting agent are combined under agitation for approximately 5 to 10 minutes at about ambient temperature to ensure adequate mixing. The specific amounts of each component in the coil coating composition are indicated below in Table 1, wherein all amounts are in parts by weight based on 100 parts by weight of the coil coating composition.

TABLE 1

| Component | | Ex. A |
|---|---|---|
| Precursor to the coil coating | Resin A | 28.00 |
| composition | Resin B | 11.00 |
| | Cross-linking agent C | 1.00 |
| | Solvent D | 35.00 |
| | Additive E | 1.00 |
| | Pigment F | 22.00 |
| Matting agent | Matting agent G | 2.00 |
| Total | | 100.00 |

Resin A is a polyvinylidine diflouride resin commercially available under the tradename Kynar® from Arkema Inc. of Philadelphia, Pa.

Resin B is an acrylic resin commercially available from BASF Corporation of Florham Park, N.J.

Cross-linking agent C is a hexamethoxymethyl melamine, commercially available under the tradename Resimene® from Solutia of St. Louis, Mo.

Solvent D is an aromatic solvent commercially available under the tradename Curox®M-100 from Degussa AG of Marl, Germany.

Additive E is a _ catalyst commercially available under the tradename Nacure® from King Industries of Norwalk, Conn.

Pigment F is titanium dioxide commercially available under the tradename TiPur® from DuPont of Wilmington, Del.

Matting agent G is a urea-formaldehyde polymer commercially available under the tradename Ceraflour® 920 from BYK-Chemie GmbH of Germany.

The coil coating composition is applied to the substrate using a two-roller process. A first roller that rotates in a first direction transfers the coil coating composition from an open holding receptacle to a second roller that rotates in an opposite direction to the first direction of the first roller. The second roller transfers the coil coating composition to the substrate.

The coil coating composition is cured on the substrate to form the cured film in an oven at a temperature of from 400° F. to 900° F. for a period of from 15 to 100 seconds. The cured film is then sprayed with water to cool the cured film on the substrate to an ambient temperature.

The article is formed by deforming the substrate coated with the cured film formed from the coil coating composition. The substrate is deformed by stamping the substrate in a stamping press into the article having a first region and a second region, corresponding to corrugated peaks and valleys in the substrate. The first region has a first film thickness, as measured in accordance with ASTM D1005, and a first gloss as measured by a glossmeter at 60° in accordance with ASTM D523. The second region has a second film thickness that is less than the first film thickness, as measured in accordance with ASTM D1005, and a second gloss as measured by the glossmeter at 600 in accordance with ASTM D523. The second film thickness and the second gloss are measured on a peak of the substrate at about a 45° crease and about a 20° crease in the substrate. The physical properties of the cured film formed from the coil coating composition described above are indicated below in Table 2.

TABLE 2

| Physical Property | Ex. A |
|---|---|
| Gloss of first region at 60° before deformation | 11.4 |
| Gloss of first region at 60° after deformation | 11.4 |
| Gloss of second region at 60° after deformation | 10.7 |
| Film thickness of first region before deformation (mm) | 0.5 |
| Film thickness of first region after deformation (mm) | 0.5 |
| Film thickness of second region after deformation (mm) | 0.2 |

### COMPARATIVE EXAMPLES

A conventional article including a cured film formed from a conventional coil coating composition is produced for comparison to the article of the present invention. More specifically, the conventional article is produced by applying the conventional coil coating composition to a substrate and curing the conventional coil coating composition to form the cured film.

The conventional coil coating composition is produced by a batch blending process where components of the conventional coil coating composition are combined under agitation for approximately 5 to 10 minutes at about ambient temperature to ensure adequate mixing. The specific amounts of each component in the conventional coil coating composition are indicated below in Table 3, wherein all amounts are in parts by weight based on 100 parts by weight of the conventional coil coating composition.

TABLE 3

| | | Comp. |
|---|---|---|
| Component | | Ex. A |
| Precursor to the coil coating | Resin A | 28.00 |
| composition | Resin B | 11.00 |
| | Cross-linking agent C | 1.00 |
| | Solvent D | 35.00 |
| | Additive E | 1.00 |
| | Pigment F | 22.00 |
| Matting agent | Matting agent H | 2.00 |
| Total | | 100.00 |

Matting agent H is a polyamide powder commercially available under the tradename Orgasol® from Arkema, Inc. of Philadelphia, Pa.

The conventional coil coating composition is applied to the substrate using a two-roller process. A first roller that rotates in a first direction transfers the conventional coil coating composition from an open holding receptacle to a second roller that rotates in an opposite direction to the first direction of the first roller. The second roller transfers the conventional coil coating composition to the substrate.

The conventional coil coating composition is cured on the substrate to form the cured film in an oven at a temperature of from 400° F. to 900° F. for a period of from 15 to 100 seconds. The cured film is then sprayed with water to cool the cured film on the substrate to an ambient temperature.

The conventional article is formed by deforming the substrate coated with the cured film formed from the conventional coil coating composition. The substrate is deformed by stamping the substrate in a stamping press into the conventional article having a first region and a second region, corresponding to corrugated peaks and valleys in the substrate. The first region has a first film thickness, as measured in accordance with ASTM D1005, and a first gloss as measured by a glossmeter at 600 in accordance with ASTM D523. The second region has a second film thickness that is less than the first film thickness, as measured in accordance with ASTM D1005, and a second gloss as measured by the glossmeter at 60° in accordance with ASTM D523. The second film thickness and the second gloss are measured on a peak of the substrate at about a 45° crease and about a 200 crease in the substrate. The physical properties of the cured film formed from the conventional coil coating composition described above are indicated below in Table 4.

TABLE 4

| Physical Property | Comp. Ex. A |
|---|---|
| Gloss of first region at 60° before deformation | 6 |
| Gloss of first region at 60° after deformation | 6 |
| Gloss of second region at 60° after deformation | 50 |
| Film thickness of first region before deformation (mm) | 0.5 |
| Film thickness of first region after deformation (mm) | 0.5 |
| Film thickness of second region after deformation (mm) | 0.2 |

### Analysis of Results

As is apparent through comparison of the physical properties of the article including the cured film formed from the coil coating composition of the present invention, as illustrated by Example A, to the physical properties of the conventional article including the cured film formed from the conventional coil coating composition, as illustrated by Comparative Example A, articles including cured films formed from coil coating compositions of the present invention exhibit a consistent gloss at 60° between a first region having a first film thickness and a second region having a second film thickness that is less than the first film thickness as compared to the conventional articles including cured films formed from conventional coil coating compositions. Consequently, the articles including cured films formed from the coil coating compositions of the present invention are more suitable than the conventional articles including cured films formed from the conventional coil coating compositions for many applications that require consistent gloss over varying film thicknesses.

Obviously, many modifications and variations of the present invention are possible in light of the above teachings. The invention may be practiced otherwise than as specifically described within the scope of the appended claims.

What is claimed is:

1. A method of forming an article including a substrate and a cured film formed from a coil coating composition on the substrate, said method comprising the steps of:
providing the coil coating composition comprising a precursor to the coil coating composition and a matting agent comprising an amide-based polymer;
applying the coil coating composition to the substrate;
curing the coil coating composition on the substrate to form the cured film having a first region having a first film thickness and a first gloss; and
deforming the substrate to establish a second region of the cured film having a second film thickness that is less than the first film thickness and a second gloss.

2. The method as set forth in claim 1 wherein the matting agent comprises at least one amide functional group.

3. The method as set forth in claim 2 wherein the amide-based polymer comprises a urea-formaldehyde polymer.

4. The method as set forth in claim 3 wherein the matting agent has a particle size of from 5 to 60 μm as measured in accordance with ISO 1524.

5. The method as set forth in claim 1 wherein the matting agent is present in the coil coating composition in an amount of from about 0.1 to 10 parts by weight based on 100 parts by weight of the coil coating composition.

6. The method as set forth in claim 1 wherein the second film thickness is less than or equal to 50% of the first film thickness.

7. The method as set forth in claim 6 wherein a difference between the first gloss and the second gloss is less than or equal to about 15% of the first gloss.

8. The method as set forth in claim 7 wherein the cured film has the first gloss of less than about 15 at all wavelengths in a visible spectrum as measured by a glossmeter at 60° in accordance with ASTM D523.

9. The method as set forth in claim 1 wherein the precursor to the coil coating composition comprises:
a resin; and
a cross-linking agent reactive with the resin.

10. The method as set forth in claim 9 wherein the resin is selected from the group of acrylic resins, polyvinylidine difluoride resins, polyester resins, siliconized polyester resins, polyvinyl chloride plastisol resins, and combinations thereof.

11. The method as set forth in claim 9 wherein the cross-linking agent is further defined as a melamine resin.

12. The method as set forth in claim 1 wherein the substrate is metal.

13. The method as set forth in claim 1 wherein said step of deforming the substrate is further defined as at least one operation selected from the group of bending, folding, stamping, twisting, shaping, and combinations thereof.

14. The method as set forth in claim 1 wherein said step of applying the coil coating composition comprises providing the coil coating composition on at least one roller and transferring the coil coating composition from the at least one roller to the substrate.

15. The method as set forth in claim 1 wherein said step of curing the coil coating composition is conducted at a temperature of from about 400° F. to 900° F. for a period of from about 15 to 100 seconds.

16. The method as set forth in claim 1 further comprising the step of cooling the cured film formed from the coil coating composition to about an ambient temperature.

17. A coil coating system comprising:
a substrate; and
a cured film disposed on said substrate and having a first region having a first film thickness and a first gloss and a second region having a second film thickness that is less than the first film thickness and a second gloss;
wherein the cured film is formed from a coil coating composition comprising a precursor to the coil coating composition and a matting agent comprising an amide-based polymer.

18. The coil coating system as set forth in claim 17 wherein the matting agent comprises at least one amide functional group.

19. The coil coating system as set forth in claim 18 wherein the amide-based polymer comprises a urea-formaldehyde polymer.

20. The coil coating system as set forth in claim 19 wherein the matting agent has a particle size of from 5 to 60 μm as measured in accordance with ISO 1524.

21. The coil coating system as set forth in claim 17 wherein the matting agent is present in the coil coating composition in an amount of from about 0.1 to 10 parts by weight based on 100 parts by weight of the coil coating composition.

22. The coil coating system as set forth in claim 17 wherein the second film thickness is less than or equal to 50% of the first film thickness.

23. The coil coating system as set forth in claim 22 wherein the difference between the first gloss and the second gloss is less than about 15% of the first gloss.

24. The coil coating system as set forth in claim 23 wherein said cured film has the first gloss of less than about 15 at all wavelengths in a visible spectrum as measured by a glossmeter at 60° in accordance with ASTM D523.

25. The coil coating system as set forth in claim 17 wherein the precursor to the coil coating composition comprises:
a resin; and
a cross-linking agent reactive with the resin.

26. The coil coating system as set forth in claim 25 wherein the resin is selected from the group of acrylic resins, polyvinylidine difluoride resins, polyester resins, siliconized polyester resins, polyvinyl chloride plastisol resins, and combinations thereof.

27. The coil coating system as set forth in claim 25 wherein the cross-linking agent is further defined as a melamine resin.

28. The coil coating system as set forth in claim 17 wherein said substrate is metal.

29. The coil coating system as set forth in claim 17 wherein the second region is established by deforming said substrate by at least one operation selected from the group of bending, folding, stamping, twisting, shaping, and combinations thereof.

30. The coil coating system as set forth in claim 17 wherein the coil coating composition is applied by providing the coil coating composition on at least one roller and transferring the coil coating composition from the at least one roller to said substrate.

31. The coil coating system as set forth in claim 17 wherein the coil coating composition is cured at a temperature of from about 400° F. to 900° F. for a period of from about 15 to 100 seconds to form said cured film.

32. The coil coating system as set forth in claim 17 wherein said cured film is cooled to about an ambient temperature.
